(19) United States
(12) Patent Application Publication
(10) Pub. No.: US 2025/0260361 A1
(43) Pub. Date: Aug. 14, 2025

(54) PHOTOVOLTAIC DEVICE, PHOTOVOLTAIC METHOD AND SNOW MELTING METHOD

(71) Applicant: SSE LLC, Kushiro-shi (JP)

(72) Inventor: HIROYA SAKURAI, KUSHIRO-SHI (JP)

(21) Appl. No.: 19/048,140

(22) Filed: Feb. 7, 2025

(30) Foreign Application Priority Data
Feb. 14, 2024 (JP) 2024-020101

(51) Int. Cl. H02S 40/12; H02S 20/10; H02S 50/00

(52) U.S. Cl. CPC H02S 40/12; H02S 20/10; H02S 50/00

(57) ABSTRACT

The invention provides a photovoltaic device, a photovoltaic method and a snow melting method which can efficiently generate power even at a snow falling time when the snow is accumulated on the photovoltaic panel. In a photovoltaic unit in which panels having photovoltaic modules converting light into electric power are connected in series, snow is accumulated in a snow accumulation part when snow falling, and power is generated without accumulated with snow in a non-snow accumulation part when snow falling. A switching unit is provided to switch a power output circuit to a bypass circuit. The power output circuit connects in series the photovoltaic unit and a power conditioner utilizing electric power generated by the photovoltaic unit. The bypass circuit connects an output terminal side and an input terminal side of the photovoltaic unit in such a manner as to bypass the power conditioner.

### TECHNICAL FIELD

The present invention relates to a photovoltaic device, a photovoltaic method, and a snow melting method, and more particularly to a photovoltaic device, a photovoltaic method, and a snow melting method for converting received light into electric power.

### BACKGROUND ART

Conventionally, photovoltaic generation has been developed in which light irradiated from the sun is received by solar photovoltaic power generation panels in which solar battery cells are arranged, and the light energy is converted into electricity.

However, the solar photovoltaic panels have a problem that the solar light is blocked when the snow is accumulated on the surfaces of the solar photovoltaic panels, mainly in heavy snowfall areas, thereby causing reduction in the power generation amount. For this reason, there has been developed a solar photovoltaic panel including a snow melting function for melting the snow that accumulated on the solar photovoltaic panel (for example, patent literature 1).

FIG. 10 is a block diagram showing an overview of the snow melting device disclosed in the patent literature 1.

As shown in FIG. 10, the snow melting device 10 disclosed in the patent literature 1 is configured to melt the snow that accumulates on a light-receiving surface side of the solar panel 20 in the solar photovoltaic device. Specifically, the snow melting device 10 has a fluent material functioning as a heat medium such as ethylene glycol in an inner part thereof, and is provided with a snow melting unit 11 which is placed in a back side corresponding to the side opposite to a light-receiving surface of the solar panel 20 in the solar photovoltaic device, a heating unit 12 for heating the fluent material, a circulation unit 13 for circulating the fluent material in an inner part of the snow melting unit 11, a control unit for controlling operations of the heating unit 12 and the circulation unit 13, and a power supply unit 15 for supplying the electric power to the heating unit 12, the circulation unit 13 and the control unit 14.

In the snow melting device 10 disclosed in the patent literature 1, the heated fluent material circulates in the inner part of the snow melting device 11 placed in the back side of the solar panel 20 by the heating unit 12 and the circulation unit 13 which are operated by the electric power supplied by the power supply unit 15. Therefore, the snow accumulated on the solar photovoltaic panel can be melted.

### CITATION LIST

### Patent Literature

Patent Literature 1: Japanese Unexamined Patent Publication No. 2024-002307

### SUMMARY OF INVENTION

### Technical Problem

However, in the snow melting device 10 disclosed in the patent literature 1, the power supply unit 15 necessarily supplies the electric power to the heating unit 12 and the circulation unit 13 for allowing the heated fluent material to circulate in the inner part of the snow melting unit 11. Therefore, it has a problem that a lot of cost is required for heating and circulating the fluent material.

In general, the energy conversion efficiency of the currently distributing solar panel is said to be about 15% to 20%, and a power generation efficiency is not good. It is not efficient to heat the fluent material and circulate the heated fluent material in the inner part of the snow melting unit 11 by the use of the external power supply only for melting the snow accumulated on the solar panel.

Further, in order to heat the fluent material and circulate the heated fluent material in the inner part of the snow melting unit 11, it is necessary to supply the electric power to the heating unit 12 and the circulation unit 13 by the power supply unit 15. Therefore, the snow melting device 10 disclosed in the patent literature 1 cannot be used without any external power supply, which means that there is a problem that the snow accumulated on the solar photovoltaic panel cannot be melted without any external power supply.

For example, it could be expected that the fluent material is heated and the heated fluent material is circulated in the inner part of the snow melting unit 11 by supplying the electric power generated by the solar panel 20 to the heating unit 12 and the circulation unit 13. However, the solar panel 20 cannot generate power in a state in which the snow is accumulated on the solar panel 20.

Thus, the electric power generated by the solar panels 20 cannot be supplied to the heating unit 12 and the circulation unit 13. Thus, in the snow melting device 10 disclosed in the patent literature 1, the electric power generated by the solar panels 20 cannot melt the snow accumulated on the own solar panel 20.

The present invention is made by taking into consideration the points mentioned above, and an object of the present invention is to provide a photovoltaic device, a photovoltaic method and a snow melting method which can efficiently generate power even at a snow falling time when the snow accumulates on the photovoltaic panels.

### Solution to Problem

In order to solve the problem mentioned above, according to the present invention, there is provided a photovoltaic device converting received light into electric power, the photovoltaic device comprising:
a photovoltaic unit having, among panels having photovoltaic modules for converting the light into the electric power, a snow accumulation part on which the snow accumulates when snow falling and a non-snow accumulation part on which the snow does not accumulate when snow falling, the snow accumulation part and the non-snow accumulation part being connected in series therein;
a power output circuit connecting in series the photovoltaic unit and an external device which utilizes the electric power generated by the photovoltaic unit;
a bypass circuit which connects an output terminal side and an input terminal side of the photovoltaic unit in such a manner as to bypass the external device; and
a switching unit which allows the photovoltaic unit to be switched to either the power output circuit or the bypass circuit.

Accordingly, the snow is accumulated in the snow accumulation part in the photovoltaic unit in which the panels having the photovoltaic modules converting the light into the electric power are connected in series, when snow falling, the power is generated without snow accumulation in the non-snow accumulation part, when snow falling, and the switching unit switches the power output circuit to the bypass circuit.

Further, according to the present invention, there is provided a photovoltaic method for converting received light into electric power, the method comprising:
a step of accumulating snow on a snow accumulation part in a photovoltaic unit in which panels having photovoltaic modules converting the light into the electric power are connected in series, when snow falling;
a step of generating power without snow accumulation in a non-snow accumulation part in the photovoltaic unit when snow falling; and
a step of allowing a switching unit to switch a power output circuit connecting in series the photovoltaic unit and an external device which utilizes the electric power generated by the photovoltaic unit to a bypass circuit which connects an output terminal side and an input terminal side of the photovoltaic unit in such a manner as to bypass the external device, when the snow accumulation part is accumulated with the snow.

Accordingly, the snow is accumulated in the snow accumulation part in the photovoltaic unit in which the panels having the photovoltaic modules converting the light into the electric power are connected in series, when snow falling, the power is generated without snow accumulation in the non-snow accumulation part in the photovoltaic unit, when snow falling, and the switching unit switches the power output circuit to the bypass circuit, when the snow accumulation part is accumulated with the snow.

Further, according to the present invention, there is provided a snow melting method executed by a photovoltaic device comprising: a photovoltaic unit having, among panels having photovoltaic modules for converting the light into the electric power, a snow accumulation part on which the snow accumulates when snow falling and a non-snow accumulation part on which the snow does not accumulate when snow falling, the snow accumulation part and the non-snow accumulation part being connected in series therein; a power output circuit connecting in series the photovoltaic unit and an external device which utilizes the electric power generated by the photovoltaic unit; a bypass circuit which connects an output terminal side and an input terminal side of the photovoltaic unit in such a manner as to bypass the external device; and a switching unit which allows the photovoltaic unit to be switched to either the power output circuit or the bypass circuit; wherein the method comprises: a step of accumulating snow in the snow accumulation part when snow falling; a step of switching the power output circuit to the bypass circuit by the switching unit; a step of generating power without snow accumulation in the non-snow accumulation part; a step of applying voltage caused by the power generation of the non-snow accumulation part to the snow accumulation part; and a step of generating heat in the snow accumulation part.

Accordingly, the snow accumulation part is accumulated with snow when snow falling, the switching unit switches the power output circuit to the bypass circuit, the non-snow accumulation part generates power without snow accumulation, the voltage caused by the power generation of the non-snow accumulation part is applied to the snow accumulation part, and the snow accumulation part generates heat.

### Effect of Invention

According to the photovoltaic device, the photovoltaic method, and the snow melting method of the present invention, the snow is accumulated in the snow accumulation part in the photovoltaic unit in which the panels having the photovoltaic modules converting the light into the electric power are connected in series, when snow falling, the power is generated without snow accumulation in the non-snow accumulation part when snow falling, and the switching unit switches the power output circuit which connects in series the photovoltaic unit and the external device utilizing the electric power generated by the photovoltaic unit to the bypass circuit which connects the output terminal side and the input terminal side of the photovoltaic unit in such a manner as to bypass the external device. Therefore, the following effects can be obtained.

The power can be generated in the non-snow accumulation part without snow accumulation even when snow falling. Therefore, the voltage generated by the non-snow accumulation part is applied to the snow accumulation part connected in series to the non-snow accumulation part, by the switching operation of the switching unit to the bypass circuit connecting the output terminal side and the input terminal side of the photovoltaic unit in such a manner as to bypass the external device utilizing the electric power generated by the photovoltaic unit, when the snow accumulation part is accumulated with the snow by the snow falling.

However, the snow accumulation part in the snow accumulated state is in a state in which the power cannot be generated and a resistance value is high, and the voltage caused by the power generation of the non-snow accumulation part is applied to the snow accumulation part in the high resistance value due to the snow accumulation. Thus, the snow accumulation part generates heat. As a result, the snow accumulated in the snow accumulation part is melted by the heat quantity generated by the heat generation of the snow accumulation part.

Further, in a case where the snow accumulation part is not in the snow accumulated state without snow falling, or in a case where the snow accumulated in the snow accumulation part melts, the snow accumulation part is not accumulated with the snow, so that the power generation can be achieved.

Therefore, the electric power caused by the power generation of the snow accumulation part and the non-snow accumulation part flows to the external device which is connected in series to the photovoltaic unit, by the switching operation of the switching unit to the power output circuit.

Accordingly, the accumulated snow can be melted by the heated snow accumulation part without necessity of the external electric power. Then, the power can be efficiently generated even at the snow falling time when the snow is accumulated in the photovoltaic panel.

### BRIEF DESCRIPTION OF DRAWINGS

FIG. 1 is a block diagram showing a concept of a power generation mode in a photovoltaic device according to a first embodiment.

FIG. 2 is a block diagram showing a concept of a snow melting mode in the photovoltaic device according to the first embodiment.

FIG. 3 is a flow chart showing a process from determination of a control unit whether or not a snow accumulation part is accumulated, to completion of snow melting in a photovoltaic unit.

FIG. 4 is a flow chart showing a process from detection of temperature of the snow accumulation part by a temperature sensor, to switching of a switching unit from the power generation mode to the snow melting mode due to an operation of the control unit.

FIG. 5 is a flow chart showing a process from the detection of the temperature of the snow accumulation part by the temperature sensor, to the switching of the switching unit from the snow melting mode to the power generation mode due to the operation of the control unit.

FIG. 6 is a thermography image showing a surface temperature in a state in which the temperature of the snow accumulation part rises in a power generation unit by switching the photovoltaic device to the snow melting mode.

FIG. 7 is a block diagram showing a concept of a power generation mode in a photovoltaic device according to a second embodiment.

FIG. 8 is a block diagram showing a concept of a snow melting mode in the photovoltaic device according to the second embodiment.

FIG. 9A is a cross sectional view showing a concept of an installation example of a non-snow accumulation panel in the photovoltaic device according to the second embodiment.

FIG. 9B is a cross sectional view showing a concept of an installation example of a one side photovoltaic panel in the photovoltaic device according to the second embodiment.

FIG. 10 is a block diagram showing a snow melting device disclosed in the patent literature 1.

### DESCRIPTION OF EMBODIMENTS

A description will be in detail given below of embodiments according to the present invention with reference to the accompanying drawings.

### First Embodiment

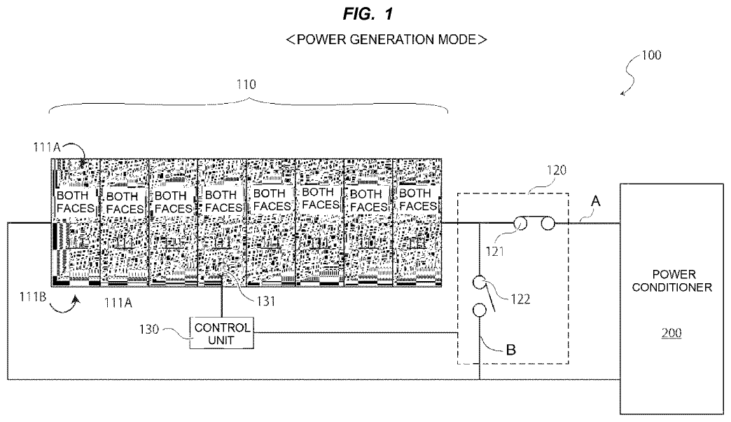

FIG. 1 is a block diagram showing a concept of a power generation mode in a photovoltaic device 100 according to a first embodiment.

As shown in FIG. 1, the photovoltaic device 100 is provided with a photovoltaic unit 110, a switching unit 120, and a control unit 130.

Electricity generated by the photovoltaic device 100 is converted from a DC power to an AC power by a power conditioner 200 which is connected to the photovoltaic device 100 by a connection cable and corresponds to an external device utilizing the electricity generated by the photovoltaic device 100, and is sent to a distribution board (not shown here).

The power conditioner 200 is shown as an example of the external device which converts into the AC power with the use of the DC power generated by the photovoltaic device 100. However, the other devices can be used as the external device utilizing the DC power generated by the photovoltaic device 100, as long as the electricity generated by the photovoltaic device 100 can be used as the DC power.

The photovoltaic unit 110 is constructed by connecting in series both sides photovoltaic panels 111 for the photovoltaic panels having photovoltaic modules converting the light into the electric power, the both sides photovoltaic panels 111 generating power by receiving the light irradiated from an upper space side and the light reflected on the ground.

Further, the photovoltaic device 100 is placed, for example, in a roof of a dwelling house, a factory and a warehouse, and an open space which does not block the solar light. Further, in order to allow the sun beam to directly apply, the photovoltaic unit 110 is preferably placed at an inclination of about 30 degrees with respect to the horizontal surface, however, can be placed at an optional inclination.

In particular, the both sides photovoltaic panels 111 are provided with front faces 111A in which the photovoltaic modules generate power by receiving the light irradiated from the upper space side, and back faces 111B which are disposed in the side opposite to the front faces 111A and in which the photovoltaic modules generate power by receiving the light reflected on the ground, and are connected in series.

The photovoltaic unit 110 is placed at an inclination of about 30 degrees with respect to the horizontal surface. Therefore, in a case where the photovoltaic unit 110 is accumulated by snow falling, the front face 111A in the both sides photovoltaic panel 111 comes to a snow accumulation part where the snow accumulates. Further, the back face 111B is disposed in the side opposite to the front face 111A, and accordingly comes to a non-snow accumulation part where the snow does not accumulate when snow falling.

The switching unit 120 is configured to switch a power output circuit A which connects the photovoltaic unit 110 and the power conditioner 200 in series, and a bypass circuit B which connects an output terminal side and an input terminal side of the photovoltaic unit 110 in such a manner as to bypass the power conditioner 200. That is, the switching unit 120 is configured to allow the photovoltaic unit 110 to be switched to either the power output circuit A or the bypass circuit B.

In particular, the switching unit 120 is provided with a first switch 121 which switches connection and disconnection of connecting wires of the power conditioner 200 and the photovoltaic unit 110, and a second switch 122 which switches connection and disconnection of connecting wires connected to the output terminal side and the input terminal side of the photovoltaic unit 110.

When the second switch 122 is in a disconnected state in a state in which the first switch 121 is connected, the photovoltaic device 100 forms a closed circuit in which the photovoltaic unit 110 and the power conditioner 200 are connected in series, and the electric power generated by the photovoltaic unit 110 flows to the power conditioner 200.

As a result, the power conditioner 200 can convert to the AC power with the use of the DC power generated by the photovoltaic unit 110. Hereinafter, the state in which the switching unit 120 switches to the power output circuit A which connects the photovoltaic unit 110 and the power conditioner 200 in series is called as a power generation mode.

Further, when the second switch 122 is in a connected state in a state in which the first switch 121 is disconnected, the photovoltaic device 100 forms a closed circuit which is connected to the output terminal side and the input terminal side of the photovoltaic unit 110, that is, a circuit short-circuiting the photovoltaic unit 110. Hereinafter, the state in which the switching unit 120 switches to the bypass circuit B bypassing the power conditioner 200 is called as a snow melting mode.

The switching unit 120 switches the circuit of the photovoltaic device 100 to the snow melting mode. As a result, it is possible to melt the snow accumulated in the front face 111A corresponding to the snow accumulation part, when the photovoltaic unit 110 is accumulated with the snow due to the snow falling.

In particular, the back face 111B corresponding to the non-snow accumulation part is not accumulated with the snow even when snow falling. Even if the front face 111A is accumulated with the snow due to the snow falling, the back face 111B can generate power by receiving the light reflected on the ground, as long as the light is reflected on the ground.

The switching unit 120 switches to the snow melting mode when the front face 111A corresponding to the snow accumulation part is accumulated with the snow due to the snow falling. As a result, the voltage caused by the power generation of the back face 111B corresponding to the non-snow accumulation part is applied to the front face 111A corresponding to the snow accumulation part which is connected in series to the back face 111B corresponding to the non-snow accumulation part.

However, the front face 111A corresponding to the snow accumulation part in the snow accumulated state cannot generate power since the light is blocked by the accumulated snow. Therefore, the front face 111A corresponding to the snow accumulation part cannot generate power, and comes to a state in which the resistance value is high.

The voltage caused by the power generation of the back face 111B corresponding to the non-snow accumulation part is applied to the front face 111A corresponding to the snow accumulation part in the high resistance value state.

Thus, the front face 111A corresponding to the snow accumulation part generates heat. The front face 111A corresponding to the snow accumulation part generates heat, and the snow accumulated in the front face 111A can be accordingly melted.

Further, in a state in which the front face 111A corresponding to the snow accumulation part is not accumulated with the snow without snow falling, or in a state in which the snow accumulated in the front face 111A corresponding to the snow accumulation part melts, the front face 111A corresponding to the snow accumulation part is not accumulated with the snow, and the power can be accordingly generated.

Therefore, when the switching unit 120 switches the circuit of the photovoltaic device 100 from the snow melting mode to the power generation mode, the electric power caused by the power generation of the front face 111A corresponding to the snow accumulation part and the back face 111B corresponding to the non-snow accumulation part flows to the power conditioner 200 which is connected in series to the photovoltaic unit 110.

Accordingly, in the photovoltaic device 100 according to the present embodiment, the front face 111A corresponding to the snow accumulation part generates heat without necessity of the external electric power, and can melt the snow accumulated in the front face 111A corresponding to the snow accumulation part. Thus, it is possible to efficiently generate power even at the snow falling time when the snow is accumulated in the photovoltaic unit 110.

The control unit 130 is connected to the switching unit 120, and is configured to control an operation of the switching unit 120 which switches the power output circuit A and the bypass circuit B. In particular, the connection and the disconnection of the first switch 121 and the second switch 122 are switched according to a command of the control unit 130.

Further, the control unit 130 is connected to a snow accumulated state determining circuit which determines a snow accumulated state of the photovoltaic unit 110, and applies to the switching unit 120 a command for allowing the switching unit 120 to be switched to either the power generation mode or the snow melting mode in response to the determination of the snow accumulated state by the snow accumulated state determining means.

In particular, the snow accumulated state determining circuit is a temperature sensor 131 which is disposed in a part of the photovoltaic unit 110. Especially, the temperature sensor 131 disposed in the back face 111B corresponding to the back side of the photovoltaic unit 110 determines whether or not the photovoltaic unit 110 is accumulated with the snow, that is, whether or not the front face 111A corresponding to the snow accumulation part is accumulated with the snow, in correspondence to a detected temperature.

The snow accumulated state determining circuit can determine the snow accumulated state by monitoring with a camera, in addition to the temperature sensor 131. Further, the snow accumulated state can be determined by a sensor which is disposed in the front face 111A corresponding to the front face of the photovoltaic unit 110 and detects the height or depth of the accumulated snow.

When the control unit 130 determines that the front face 111A is accumulated with the snow, the control unit 130 applies to the switching unit 120 a command for switching the circuit of the photovoltaic device 100 to the snow melting mode, and when the control unit 130 determines that the front face 111A is not accumulated with the snow, the control unit 130 applies to the switching unit 120 a command for switching the circuit of the photovoltaic device 100 to the power generation mode.

Further, in the determination of the snow accumulated state by the snow accumulated state determining circuit using the specific temperature sensor 131, the temperature sensor 131 determines that the front face 111A is accumulated with the snow when a predetermined temperature (for example, 0° C.) or less at which the temperature sensor 131 determines the snow accumulated state is continuously kept for a predetermined period (for example, 300 seconds), and the control unit 130 applies to the switching unit 120 a command for switching the circuit of the photovoltaic device 100 to the snow melting mode.

Further, the temperature sensor 131 determines that the front face 111A is not accumulated with the snow when a predetermined temperature (for example, 10° C.) or more at which the temperature sensor 131 determines the non-snow accumulated state is continuously kept for a predetermined period (for example, 300 seconds), and the control unit 130 applies to the switching unit 120 a command for switching the circuit of the photovoltaic device 100 to the power generation mode.

As mentioned above, in the photovoltaic device 100 according to the present embodiment, it is possible to melt the accumulated snow by the snow accumulation part which is heated without necessity of the external electric power. More specifically, it is possible to efficiently generate power even at the snow falling time when the snow is accumulated in the photovoltaic panel.

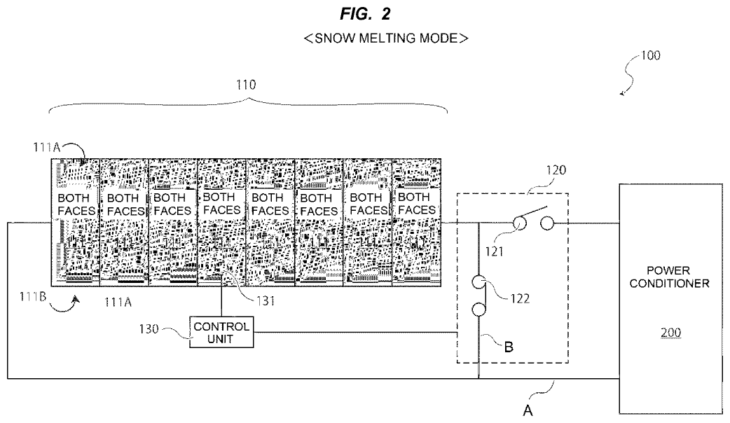

FIG. 2 is a block diagram showing a concept of the snow melting mode in the photovoltaic device 100 according to the first embodiment.

As shown in FIG. 2, when the switching unit 120 switches to the snow melting mode, that is, switches to the bypass circuit B which bypasses the power conditioner 200, it is possible to melt the snow accumulated in the front face 111A forming the snow accumulation part due to the snow falling.

In particular, the back face 111B corresponding to the non-snow accumulation part is not accumulated with the snow even when snow falling. Even if the front face 111A is accumulated with the snow due to the snow falling, the back face 111B can generate power by receiving the light reflected on the ground.

When the switching unit 120 switches from the power generation mode to the snow melting mode in a case where the front face 111A corresponding to the snow accumulation part is accumulated with the snow due to the snow falling, the voltage caused by the power generation of the back face 111B corresponding to the non-snow accumulation part is applied to the front face 111A corresponding to the snow accumulation part which is connected in series to the back face 111B corresponding to the non-snow accumulation part.

However, the front face 111A corresponding to the snow accumulation part in the snow accumulated state cannot generate power since the light is blocked by the accumulated snow. Thus, the front face 111A corresponding to the snow accumulation part cannot generate power and in a high resistance value state.

The voltage caused by the power generation of the back face 111B corresponding to the non-snow accumulation part is applied to the front face 111A corresponding to the snow accumulation part in the high resistance value state. As a result, the front face 111A corresponding to the snow accumulation part generates heat. It is possible to melt the snow accumulated in the front face 111A by the heat generation of the front face 111A corresponding to the snow accumulation part.

Further, in a state in which the front face 111A corresponding to the snow accumulation part is not accumulated with the snow without snow falling, or in a state in which the snow accumulated in the front face 111A corresponding to the snow accumulation part is melted, the front face 111A corresponding to the snow accumulation part is not accumulated with the snow, and can generate power.

Therefore, when the switching unit 120 switches the circuit from the snow melting mode to the power generation mode, the electric power caused by the power generation of the front face 111A corresponding to the snow accumulation part and the back face 111B corresponding to the non-snow accumulation part flows to the power conditioner 200 which is connected in series to the photovoltaic unit 110.

As a result, the photovoltaic device 100 according to the present embodiment can melt the snow accumulated in the front face 111A corresponding to the snow accumulation part by the heat generation of the front face 111A corresponding to the snow accumulation part without necessity of the external electric power. Consequently, it is possible to efficiently generate power even at the snow falling time when the snow accumulates in the photovoltaic unit 110.

As described above, in the photovoltaic device 100 according to the present embodiment, it is possible to melt the accumulated snow by the heated snow accumulation part without necessity of the external electric power. More specifically, it is possible to efficiently generate power even at the snow falling time when the snow is accumulated in the photovoltaic panel.

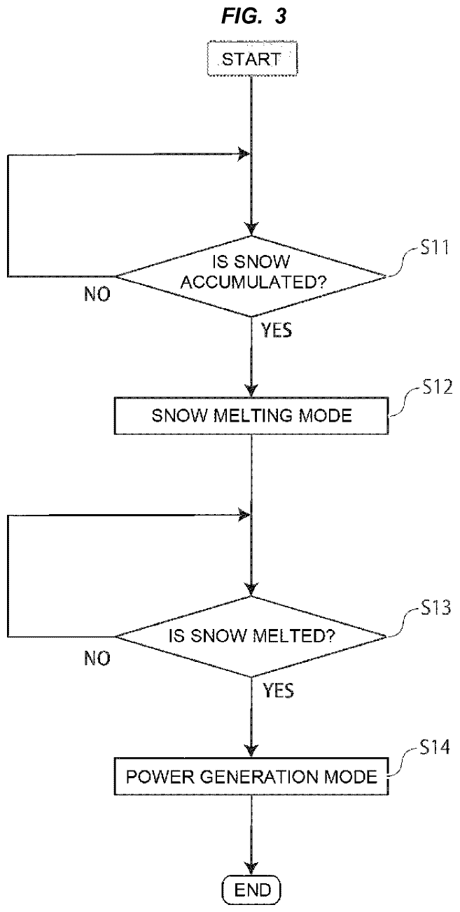

FIG. 3 is a flow chart showing a process until the snow melting of the photovoltaic unit 110 is completed after the control unit 130 determines whether or not the snow accumulation part is accumulated with the snow. A description will be given below of the process shown in FIG. 3 according to the step numbers.

### Step S11

The control unit 130 determines whether or not the front face 111A corresponding to the snow accumulation part is accumulated with the snow.

In particular, when a predetermined temperature (for example, 0° C.) or less that the temperature sensor 131 determines the snow accumulated state is continuously kept for a predetermined period (for example, 300 seconds), the control unit 130 determines that the front face 111A is accumulated with the snow.

When the control unit 130 determines that the front face 111A corresponding to the snow accumulation part is accumulated with the snow in a step S11, the process goes to a step S12, and when the control unit 130 determines that the front face 111A corresponding to the snow accumulation part is not accumulated with the snow, the process of the step S11 is repeated.

### Step S12

The photovoltaic device 100 is switched to the snow melting mode.

In particular, the switching unit 120 switches to the snow melting mode corresponding to the bypass circuit bypassing the power conditioner 200 on the basis of the operation of the control unit 130.

### Step S13

The control unit 130 determines whether or not the front face 111A corresponding to the snow accumulation part is accumulated with the snow.

In particular, when a predetermined temperature (for example, 10° C.) or more at which the temperature sensor 131 determines the non-snow accumulated state is continuously kept for a predetermined period (for example, 300 seconds), the control unit 130 determines that the front face 111A is not accumulated with the snow.

When the control unit 130 determines that the front face 111A corresponding to the snow accumulation part is not accumulated with the snow in a step S13, the process goes to a step S14, and when the control unit 130 determines that the front face 111A corresponding to the snow accumulation part is accumulated with the snow, the process of the step S13 is repeated.

### Step S14

The photovoltaic device 100 is switched to the power generation mode.

In particular, the switching unit 120 switches to the power generation mode corresponding to the power output circuit in which the photovoltaic unit 110 and the power conditioner 200 are connected in series, on the basis of the operation of the control unit 130.

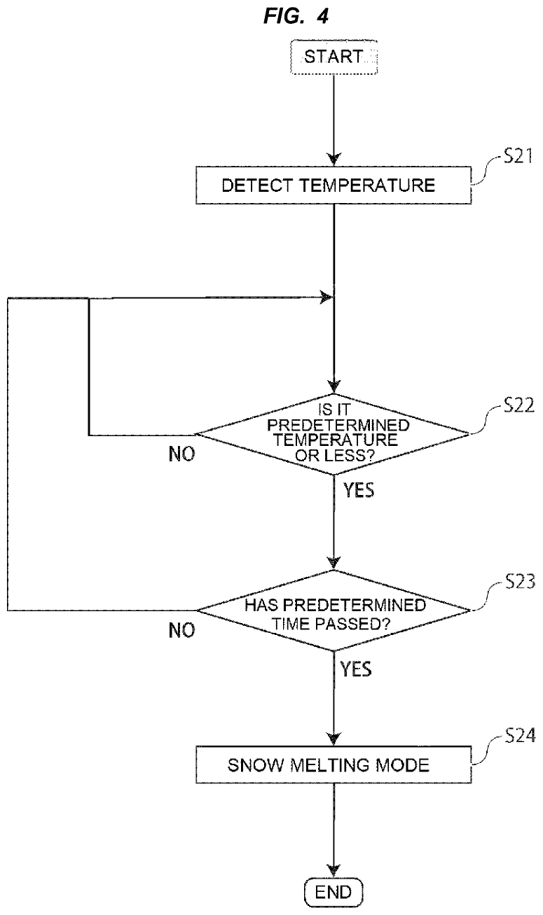

FIG. 4 is a flow chart showing a process until the switching unit switches from the power generation mode to the snow melting mode by the operation of the control unit 130 after the temperature sensor 131 detects the temperature of the snow accumulation part. A description will be given below of the process shown in FIG. 4 according to the step numbers.

### Step S21

The temperature sensor 131 detects the temperature of the front face 111A corresponding to the snow accumulation part.

In particular, the temperature sensor 131 disposed in the back side of the front face 111A corresponding to the snow accumulation part detects the temperature of the front face 111A corresponding to the snow accumulation part.

### Step S22

The control unit 130 determines whether or not the temperature of the front face 111A corresponding to the snow accumulation part is a predetermined temperature for determining the snow accumulated state.

In particular, the control unit 130 determines whether or not the temperature of the front face 111A corresponding to the snow accumulation part detected by the temperature sensor 131 in a step S21 is a predetermined temperature (for example, 0° C.) or less for determining the snow accumulated state.

When the control unit 130 determines in a step S22 that the temperature of the front face 111A corresponding to the snow accumulation part is the predetermined temperature or less for determining the snow accumulated state, the process goes to a step S23, and when the control unit 130 determines that the temperature of the front face 111A corresponding to the snow accumulation part is not the predetermined temperature or less for determining the snow accumulated state, the process of the step S22 is repeated.

### Step S23

The control unit 130 determines whether or not a predetermined time has passed continuously after first detecting the predetermined temperature for determining that the temperature of the front face 111A corresponding to the snow accumulation part indicates the snow accumulated state.

In particular, the control unit 130 determines whether or not a predetermined time (for example, 300 seconds) has passed continuously after first detecting that the temperature of the front face 111A corresponding to the snow accumulation part detected by the temperature sensor 131 in the step S22 is the predetermined temperature or less for determining the snow accumulated state.

When the control unit 130 determines in the step S23 that the predetermined temperature or less for determining that the temperature of the front face 111A corresponding to the snow accumulation part indicates the snow accumulated state is kept for the predetermined time, the process goes to a step S24, and when the control unit 130 determines that the predetermined temperature or less for determining that the temperature of the front face 111A corresponding to the snow accumulation part indicates the snow accumulated state is not kept for the predetermined time, the step goes to the step S22.

### Step 24

The photovoltaic device 100 is switched to the snow melting mode.

In particular, the switching unit 120 switches to the snow melting mode corresponding to the bypass circuit B bypassing the power conditioner 200 on the basis of the operation of the control unit 130.

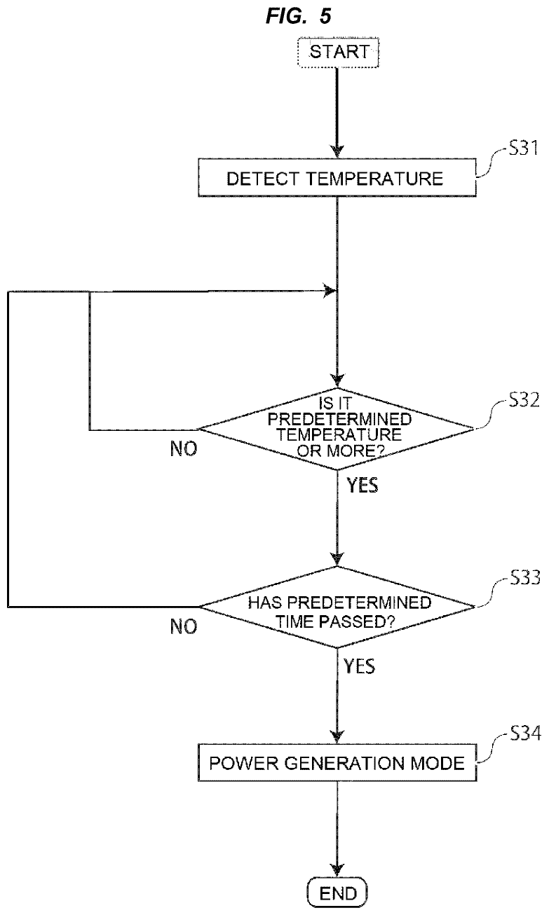

FIG. 5 is a flow chart showing a process until the switching unit 120 switches from the snow melting mode to the power generation mode on the basis of the operation of the control unit 130 after the temperature sensor 131 detects the temperature of the snow accumulation part. A description will be given below of the process shown in FIG. 5 according to the step numbers.

### Step S31

The temperature sensor 131 detects the temperature of the front face 111A corresponding to the snow accumulation part.

In particular, the temperature sensor 131 disposed in the back side of the front face 111A corresponding to the snow accumulation part detects the temperature of the front face 111A corresponding to the snow accumulation part.

### Step S32

The control unit 130 determines whether or not the temperature of the front face 111A corresponding to the snow accumulation part is the predetermined temperature for determining the non-snow accumulated state.

In particular, the control unit 130 determines whether or not the temperature of the front face 111A corresponding to the snow accumulation part detected by the temperature sensor 131 in the step S21 is the predetermined temperature (for example, 10° C.) or more for determining the non-snow accumulated state.

When the control unit 130 determines that the temperature of the front face 111A corresponding to the snow accumulation part is the predetermined temperature or more for determining the non-snow accumulated state in the step S32, the process goes to a step S33, and when the control unit 130 determines that the temperature of the front face 111A corresponding to the snow accumulation part is not the predetermined temperature or more for determining the non-snow accumulated state, the process of the step S32 is repeated.

### Step S33

The control unit 130 determines whether or not a predetermined time has passed continuously after first detecting the predetermined temperature for determining that the temperature of the front face 111A corresponding to the snow accumulation part indicates the non-snow accumulated state.

In particular, the control unit 130 determines whether or not a predetermined time (for example, 300 seconds) has passed continuously after first detecting that the temperature of the front face 111A corresponding to the snow accumulation part detected by the temperature sensor 131 in the step S32 is the predetermined temperature or more for determining the non-accumulated state.

When the control unit 130 determines that the predetermined temperature for determining that the temperature of the front face 111A corresponding to the snow accumulation part indicates the non-snow accumulated state is continuously kept for the predetermined time, the process goes to a step S34, and when the control unit 130 determines that the predetermined temperature or more for determining that the temperature of the front face 111A corresponding to the snow accumulation part indicates the non-snow accumulated state is not continuously kept, the process goes to the step S32.

### Step S34

The photovoltaic device 100 is switched to the power generation mode.

In particular, the switching unit 120 switches to the power generation mode corresponding to the power output circuit A in which the photovoltaic unit 110 and the power conditioner 200 are connected in series, on the basis of the operation of the control unit 130.

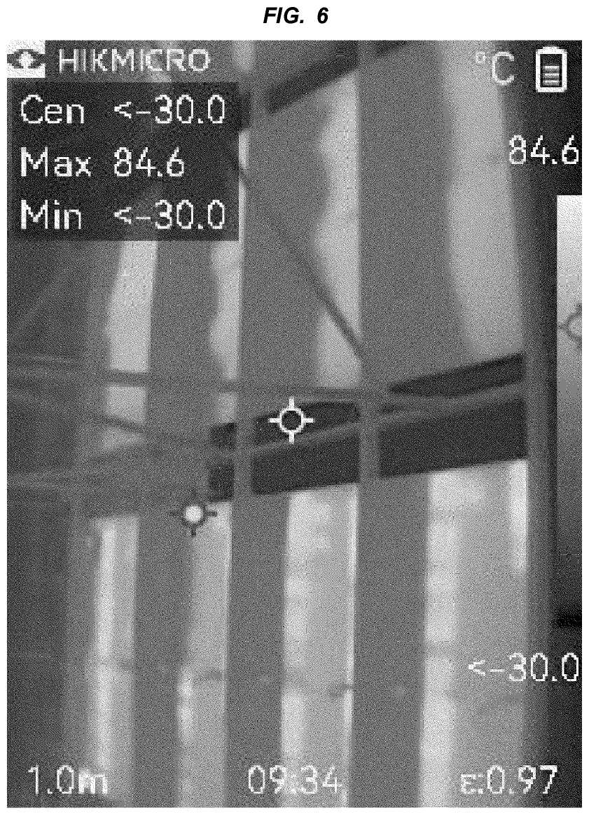

FIG. 6 is a thermography image showing a surface temperature in a state in which the temperature of the snow accumulation part in the power generation unit rises by switching the photovoltaic device to the snow melting mode.

As shown in FIG. 6, the surface temperature of the photovoltaic unit 110 maximumly rises up to 84° C., and a sufficient heat quantity required for melting the snow accumulated in the snow accumulation part can be obtained.

### Second Embodiment

Next, a description will be given of a second embodiment according to the present invention. A photovoltaic device according to the present embodiment is substantially the same as the structure shown in the first embodiment except structures of a snow accumulation part, a non-snow accumulation part, and a switching unit. Thus, a description thereof will be appropriately omitted by attaching the same reference numerals to the structures which are substantially the same as those in the first embodiment.

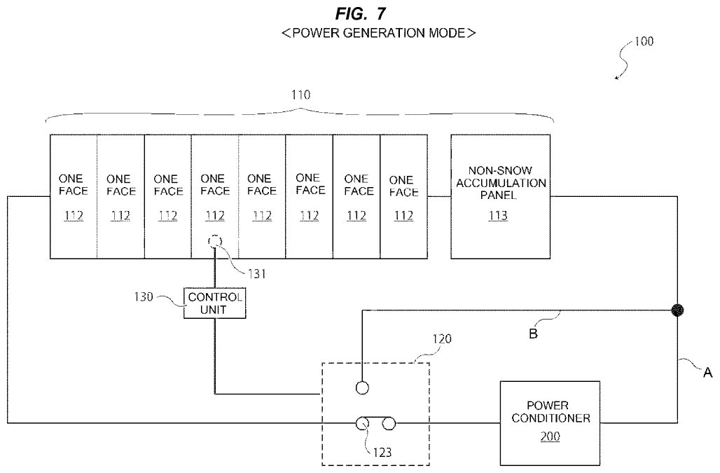

FIG. 7 is a block diagram showing a concept of a power generation mode in the photovoltaic device according to the second embodiment.

As shown in FIG. 7, a photovoltaic device 100 is provided with a photovoltaic unit 110, a switching unit 120, and a control unit 130.

The photovoltaic unit 110 is structured such that one side photovoltaic panel 112 and a non-snow accumulation panel 113 are connected in series. In the one side photovoltaic panel 112, a photovoltaic panel having a photovoltaic module converting the light into the electric power is disposed in an upper space side so as to be accumulated with the snow. In the non-snow accumulation panel 113, the photovoltaic panel having the photovoltaic module converting the light into the electric power is disposed so as to be not accumulated with the snow when snow falling.

The switching unit 120 is configured to switch a power output circuit A which connects the photovoltaic unit 110 and the power conditioner 200 in series, and a bypass circuit B which connects to an output terminal side and an input terminal side of the photovoltaic unit 110 in such a manner as to bypass the power conditioner 200.

In particular, the switching unit 120 is provided with a branch switch unit 123 which allows the photovoltaic unit 110 to be switched to either the power output circuit A which connects the output terminal side and the input terminal side of the photovoltaic unit 110 to the power conditioner 200 or the bypass circuit B which connects the output terminal side of the photovoltaic unit 110 with the input terminal side of the photovoltaic unit 110 in such a manner as to bypass the power conditioner 200.

When the branch switch unit 123 switches to the power output circuit A which connects the output terminal side and the input terminal side of the photovoltaic unit 110 to the power conditioner 200, the photovoltaic device 100 forms a closed circuit in which the photovoltaic unit 110 and the power conditioner 200 are connected in series, and the electric power generated by the photovoltaic unit 110 flows to the power conditioner 200. Thus, the power generation mode is formed in the same manner as the photovoltaic device 100 according to the first embodiment.

Further, when the branch switch unit 123 switches to the bypass circuit B which connects the output terminal side of the photovoltaic unit 110 with the input terminal side of the photovoltaic unit 110 in such a manner as to bypass the power conditioner 200, a circuit short-circuiting the photovoltaic unit 110 is formed. Thus, the snow melting mode is formed in the same manner as the photovoltaic device 100 according to the first embodiment.

By switching the branch switch unit 123 to the snow melting mode, it is possible to melt the snow accumulated in the one side photovoltaic panel 112 forming the snow accumulation part, when the snow is accumulated in the photovoltaic unit 110 by the snow falling.

In particular, the non-snow accumulation panel 113 corresponding to the non-snow accumulation part is not accumulated with the snow even when snow falling. Consequently, even in a case where the one side photovoltaic panel 112 is accumulated with the snow by the snow falling, the non-snow accumulation panel 113 can generate power by receiving the light.

When the branch switch unit 123 switches to the snow melting mode in a case where the snow is accumulated in the upper space side of the one side photovoltaic panel 112 corresponding to the snow accumulation part due to the snow falling, the voltage caused by the power generation of the non-snow accumulation panel 113 corresponding to the non-snow accumulation part is applied to the one side photovoltaic panel 112 corresponding to the snow accumulation part which is connected in series to the non-snow accumulation panel 113 corresponding to the non-snow accumulation part.

However, the one side photovoltaic panel 112 corresponding to the snow accumulation part in the snow accumulated state cannot generate power since the light is blocked by the accumulated snow. Thus, the one side photovoltaic panel 112 corresponding to the snow accumulation part cannot generate power and is in the high resistance value state.

The voltage caused by the power generation of the non-snow accumulation panel 113 corresponding to the non-snow accumulation part is applied to the one side photovoltaic panel 112 corresponding to the snow accumulation part in the high resistance value state. As a result, the one side photovoltaic panel 112 corresponding to the snow accumulation part generates heat. It is possible to melt the snow accumulated in the one side photovoltaic panel 112 by the power generation of the one side photovoltaic panel 112 corresponding to the snow accumulation part.

Further, in a state in which the one side photovoltaic panel 112 corresponding to the snow accumulation part is not accumulated with the snow without snow falling, or in a state in which the snow accumulated in the one side photovoltaic panel 112 corresponding to the snow accumulation part melts, the one side photovoltaic panel 112 corresponding to the snow accumulation part is not accumulated with the snow, and can generate power.

As a result, when the branch switch unit 123 switches the circuit to the power generation mode, the electric power caused by the power generation of the one side photovoltaic panel 112 corresponding to the snow accumulation part and the non-snow accumulation panel 113 corresponding to the non-snow accumulation part flows to the power conditioner 200 which is connected in series to the photovoltaic unit 110.

Therefore, the photovoltaic device 100 according to the present embodiment can melt the snow accumulated in the one side photovoltaic panel 112 corresponding to the snow accumulation part by the power generation of the one side photovoltaic panel 112 corresponding to the snow accumulation part without necessity of the external electric power. Consequently, it is possible to efficiently generate power even at the snow falling time when the snow accumulates in the photovoltaic unit 110.

The control unit 130 is connected to the branch switch unit 123 corresponding to the switching unit 120, and configured to control the operation of the branch switch unit 123 which switches the power output circuit A and the bypass circuit B. In particular, the branch switch unit 123 is operated according to the command from the control unit 130.

As described above, it is possible to melt the accumulated snow by the heated snow accumulation part without necessity of the external electric power. Consequently, it is possible to efficiently generate power even at the snow falling time when the snow is accumulated in the photovoltaic panel.

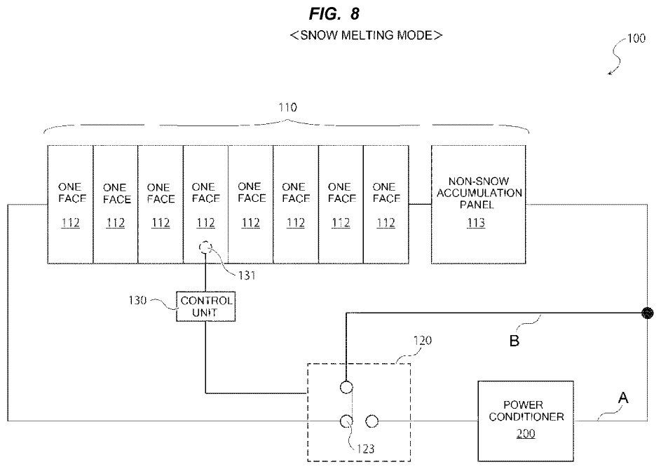

FIG. 8 is a block diagram showing a concept of a snow melting mode in the photovoltaic device according to the second embodiment.

As shown in FIG. 8, when the branch switch unit 123 switches to the snow melting mode, that is, switches to the bypass circuit bypassing the power conditioner 200, it is possible to melt the snow accumulated in the one side photovoltaic panel 112 forming the snow accumulation part due to the snow falling.

In particular, the non-snow accumulation panel 113 corresponding to the non-snow accumulation part is not accumulated with the snow even when snow falling. Consequently, the non-snow accumulation panel 113 can generate power by receiving the light even if the one side photovoltaic panel 112 is accumulated due to the snow falling.

When the branch switch unit 123 switches to the snow melting mode in a case where the one side photovoltaic panel 112 corresponding to the snow accumulation part is accumulated with the snow due to the snow falling, the voltage caused by the power generation of the non-snow accumulation panel 113 corresponding to the non-snow accumulation part is applied to the one side photovoltaic panel 112 corresponding to the snow accumulation part which is connected in series to the non-snow accumulation panel 113 corresponding to the non-snow accumulation part.

However, the one side photovoltaic panel 112 corresponding to the snow accumulation part in the snow accumulated state cannot generate power since the light is blocked by the accumulated snow. Thus, the one side photovoltaic panel 112 corresponding to the snow accumulation part cannot generate power and is in the high resistance value state.

When the voltage caused by the power generation of the non-snow accumulation panel 113 corresponding to the non-snow accumulation part is applied to the one side photovoltaic panel 112 corresponding to the snow accumulation part in the high resistance value state, the one side photovoltaic panel 112 corresponding to the snow accumulation part generates heat. It is possible to melt the snow accumulated in the one side photovoltaic panel 112 by the heat generation of the one side photovoltaic panel 112 corresponding to the snow accumulation part.

Further, in a state in which the one side photovoltaic panel 112 corresponding to the snow accumulation part is not accumulated with the snow without snow falling, or in a state in which the snow accumulated in the one side photovoltaic panel 112 corresponding to the snow accumulation part melts, the one side photovoltaic panel 112 corresponding to the snow accumulation part is not accumulated with the snow and can generate power.

Therefore, when the branch switch unit 123 switches the circuit to the power generation mode, the electric power caused by the power generation of the one side photovoltaic panel 112 corresponding to the snow accumulation part and the non-snow accumulation panel 113 corresponding to the non-snow accumulation part flows to the power conditioner 200 which is connected in series to the photovoltaic unit 110.

As a result, the photovoltaic device 100 according to the present embodiment can melt the snow accumulated in the one side photovoltaic panel 112 corresponding to the snow accumulation part by the heat generation of the one side photovoltaic panel 112 corresponding to the snow accumulation part without necessity of the external electric power. Consequently, it is possible to efficiently generate power even at the snow falling time when the snow accumulates in the photovoltaic unit 110.

As described above, it is possible to melt the accumulated snow by the heated snow accumulation part without necessity of the external electric power. Consequently, it is possible to efficiently generate power even at the snow falling time when the snow is accumulated in the photovoltaic panel.

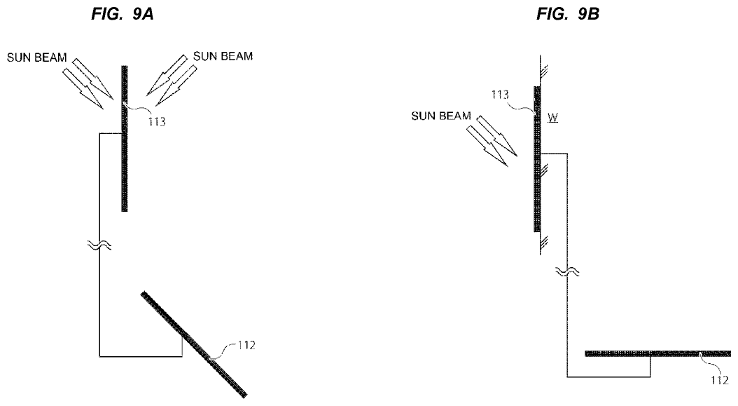

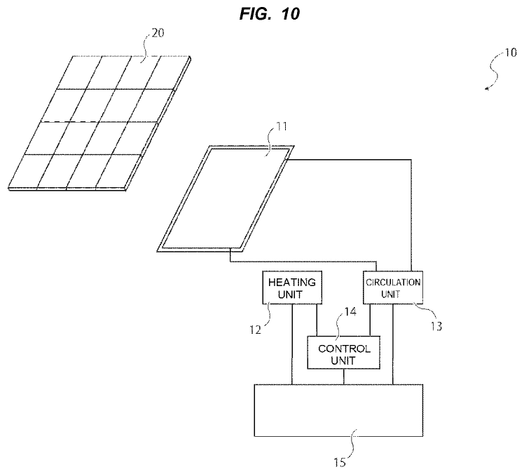

FIGS. 9A and 9B are cross-sectional views showing a concept of an installation example of a non-snow accumulation panel and a one side photovoltaic panel in the photovoltaic device according to the second embodiment.

FIG. 9A is a cross-sectional view showing an example in which the non-snow accumulation panel 113 is placed in such a manner as to be vertical to the horizontal surface, and the one side photovoltaic panel 112 is placed to be inclined with respect to the horizontal surface.

As shown in FIG. 9A, when the non-snow accumulation panel 113 is placed in such a manner as to be vertical to the horizontal surface, a power generating surface provided with the photovoltaic module of the non-snow accumulation panel 113 is directed to a horizontal direction. Thus, the front face of the non-snow accumulation panel 113 is not accumulated with the snow even when snow falling. Therefore, the non-snow accumulation panel 113 can be formed as the non-snow accumulation part.

Further, when the non-snow accumulation panel 113 is formed as the both sides photovoltaic panel 111 in which the photovoltaic modules are disposed in the front face and the back face, the light irradiated to the non-snow accumulation panel 113 is received by both side faces directed to the horizontal surface and the power can be generated.

Further, when the one side photovoltaic panel 112 is placed to be inclined to the horizontal surface, the snow is accumulated in the front face of the one side photovoltaic panel 112 at the snow falling time. Thus, the front face of the one side photovoltaic panel 112 forms the snow accumulation part.

FIG. 9B is a cross-sectional view showing an example in which the non-snow accumulation panel 113 is placed in a wall surface W expanding in a vertical direction, and the one side photovoltaic panel 112 is placed horizontally.

As shown in FIG. 9B, the power generating surface of the non-snow accumulation panel 113 is directed to the horizontal direction by placing the non-snow accumulation panel 113 in the wall surface W expanding in the vertical direction. Therefore, the snow is not accumulated in the front face of the non-snow accumulation panel 113 even when snow falling. Consequently, the non-snow accumulation panel 113 can be formed as the non-snow accumulation part.

Further, when the one side photovoltaic panel 112 is placed horizontally, the snow is accumulated in the front face of the one side photovoltaic panel 112 when snow falling.

As shown in FIG. 9B, even when the one side photovoltaic panel 112 is placed horizontally, the one side photovoltaic panel 112 generates heat and can melt the accumulated snow only by switching the photovoltaic device 100 to the snow melting mode.

Accordingly, it is possible to prevent the snow accumulation and melt the accumulated snow when snow falling, for example, by placing the one side photovoltaic panel 112 in a road surface.

As described above, it is possible to melt the accumulated snow by the heated snow accumulation part without necessity of the external electric power. As a result, it is possible to efficiently generate power even at the snow falling time when the snow accumulates in the photovoltaic panel.

1. A photovoltaic device converting received light into electric power, the photovoltaic device comprising:
a photovoltaic unit having, among panels having photovoltaic modules for converting the light into the electric power, a snow accumulation part on which the snow accumulates when snow falling and a non-snow accumulation part on which the snow does not accumulate when snow falling, the snow accumulation part and the non-snow accumulation part being connected in series therein;
a power output circuit connecting in series the photovoltaic unit and an external device which utilizes the electric power generated by the photovoltaic unit;
a bypass circuit connecting an output terminal side and an input terminal side of the photovoltaic unit in such a manner as to bypass the external device; and
a switching unit which allows the photovoltaic unit to be switched to either the power output circuit or the bypass circuit.

2. The photovoltaic device according to claim 1, further comprising a control unit which controls the switching of the circuits by the switching unit,
wherein the control unit controls the switching unit so that the switching unit switches the power output circuit to the bypass circuit in a case where the snow accumulation part is accumulated with the snow, and
wherein the control unit controls the switching unit so that the switching unit switches the bypass circuit to the power output circuit in a case where the snow accumulation part is not accumulated with the snow.

3. The photovoltaic device according to claim 2, wherein the control unit comprises a snow accumulated state determining circuit for determining whether or not the snow accumulation part is accumulated with the snow.

4. The photovoltaic device according to claim 3, wherein the snow accumulated state determining circuit determines whether or not the snow accumulation part is accumulated with the snow, in correspondence to a detected temperature which is detected by a temperature sensor disposed in the photovoltaic unit.

5. The photovoltaic device according to claim 4, wherein the control unit determines that the snow accumulation part is accumulated with the snow when a state in which the detected temperature is a predetermined temperature or less for determining the snow accumulated state is continuously kept for a predetermined time.

6. The photovoltaic device according to claim 4, wherein the control unit determines that the snow accumulation part is not accumulated with the snow when a state in which the detected temperature is a predetermined temperature or more for determining the non-snow accumulated state is continuously kept for a predetermined time.

7. The photovoltaic device according to claim 1, wherein the photovoltaic unit is a both sides photovoltaic panel which is exposed to the light and generates power in both front face and back face, the front face being the snow accumulation part which is disposed in an upper space side and is accumulated with the snow, and the back face being the non-snow accumulation part which is disposed in the side opposite to the front face.

8. The photovoltaic device according to claim 1, wherein the non-snow accumulation part is in a state in which the panels are placed vertically, and
wherein the snow accumulation part is a one side photovoltaic panel in which the photovoltaic module is disposed in an upper space side, or a both sides photovoltaic panel which is exposed to the light and generates power in both front face and back face, the front face having the photovoltaic module disposed in an upper space side, and the back face being disposed in the side opposite to the front face.

9. The photovoltaic device according to claim 8, wherein the snow accumulation part is disposed in a road surface.

10. A photovoltaic method for converting received light into electric power, the method comprising:
a step of accumulating snow on a snow accumulation part in a photovoltaic unit in which panels having photovoltaic modules converting the light into the electric power are connected in series, when snow falling;
a step of generating power without snow accumulation in a non-snow accumulation part in the photovoltaic unit when snow falling; and
a step of allowing a switching unit to switch power output circuit connecting in series the photovoltaic unit and an external device which utilizes the electric power generated by the photovoltaic unit to a bypass circuit which connects an output terminal side and an input terminal side of the photovoltaic unit in such a manner as to bypass the external device, when the snow accumulation part is accumulated with the snow.

11. A snow melting method executed by a photovoltaic device comprising:
a photovoltaic unit having, among panels having photovoltaic modules for converting the light into the electric power, a snow accumulation part on which the snow accumulates when snow falling and a non-snow accumulation part on which the snow does not accumulate when snow falling, the snow accumulation part and the non-snow accumulation part being connected in series therein;
a power output circuit connecting in series the photovoltaic unit and an external device which utilizes the electric power generated by the photovoltaic unit;
a bypass circuit which connects an output terminal side and an input terminal side of the photovoltaic unit in such a manner as to bypass the external device; and
a switching unit which allows the photovoltaic unit to be switched to either the power output circuit or the bypass circuit,
wherein the method comprises:
a step of accumulating snow in the snow accumulation part when snow falling;
a step of switching the circuit to the bypass circuit by the switching unit;
a step of generating power without snow accumulation in the non-snow accumulation part;
a step of applying voltage caused by the power generation of the non-snow accumulation part to the snow accumulation part; and
a step of generating heat in the snow accumulation part.
